(19) United States
(12) Patent Application Publication
(10) Pub. No.: US 2025/0030975 A1
(43) Pub. Date: Jan. 23, 2025

(54) 3D SOUND ANALYSIS SYSTEM

(71) Applicant: 3DS MIKE PTY LTD, Eaglehawk, Victoria (AU)

(72) Inventor: Ian Symons, Victoria (AU)

(73) Assignee: 3DS MIKE PTY LTD, Eaglehawk, Victoria (AU)

(21) Appl. No.: 18/714,375

(22) PCT Filed: Dec. 5, 2022
(86) PCT No.: PCT/AU2022/051453

§ 371 Date: May 29, 2024

(30) Foreign Application Priority Data
Dec. 3, 2021 (AU) 2021903929

(51) Int. Cl. H04R 1/26; H04R 1/08; H04R 5/027

(52) U.S. Cl. CPC H04R 1/265; H04R 1/08; H04R 5/027

(57) ABSTRACT

A system comprising sound wave sensors for high fidelity sound wave detection from any 3D directions and identification of 3D coordinates of sound sources, means to separate the sound emanations of each sound source with good to high fidelity, and means to reconstruct sound sources with good to high fidelity generally including its lobal patterns. The system enables microphones systems capable of detecting sound with substantially high linearity in frequency response, sensitivity, and directionality, combined with any desired form of volumetric sensing such as spherical, hemispherical, conic and so forth, including multiple defined lobes, or selecting any desired volume and shape. Sound wave sensors can comprise a multitude or combinations of system means such as sound beams, levitated bubble interactions, tethered bubble interactions, fibre interactions, laser interferometry, RF tuned circuit techniques, and so forth, wherein all such methods ultimately employ a form of bidirectional sound sensing means.

### TECHNICAL FIELD

This disclosure relates to a three-dimensional (3D) sound analysis system. In particular, to detect sound waves in three dimensions and analyse the output signals.

### BACKGROUND

Microphones and systems for detecting sound are generally substantially non-linear in frequency response, sensitivity, and directionality.

Their directionality options are also substantially limited.

Attempting to employ such microphones for 3D sound applications exacerbates these problems.

It is desirable to provide microphone systems capable of detecting sound with substantially high linearity in frequency response, sensitivity, and directionality, combined with any desired form of directionality such as spherical, hemispherical, conic or selecting any desired volume and shape, or any combination or number thereof. This system would suit both professional microphone applications and 3D applications.

It is further desirable to provide a microphone system to identify the 3D coordinates of most or all of the detected sound sources, means to separate the sound emanations of each sound source with good to high fidelity, and means to reconstruct the sound source at its origin with good to high fidelity generally including its lobal patterns.

### SUMMARY

In this specification unless otherwise specified, terms and acronyms used in this document are:
(i) The acronym “3D” refers to the term three dimensional;
(ii) The term “sound source” refers to any 3D location emitting detectable sound;
(iii) The term “bidirectional microphone” or “FIG. 8 microphone” re their polar patterns, are the microphone types used in this document;
(iv) The term “bidirectional vectors” refers to opposite directions, one leading to a real sound source and one leading to a false sound source, being the characteristic of all bidirectional microphones to every detectable sound source;
(v) The terms “displacement”, “position”, and “vibration” are interchangeable in relation to the motion of a sound sensitive component reacting to sound waves;
(vi) The terms “tether” and “fibre” are interchangeable in relation to the anchoring of a sound sensitive component reacting to sound waves;
(vii) The term “UV” refers to ultra violet light;
(viii) The term “epoxy” generally refers to UV curable epoxy whereby the resin upon exposure to UV will fully cure typically in seconds;
(ix) The term “LED” refers to a light emitting diode;
(x) The acronym “CMUT” refers to “Capacitive Micromachined Ultrasonic Transducer”;
(xi) The term “CMUT beam” refers to the emitted sonic beam of a CMUT;
(xii) The term “axes” refers to coordinate axis;
(xiii) The term “3D responsive microphone module” is interchangeable with the terms “microphone module” or “bidirectional microphone” or “microphone”;
(xiv) The term “bidirectional vector information” is interchangeable with the term “bidirectional information” (xv)
(xv) The term “RF” refers to radio frequency; and
(xvi) The term “FM” refers to frequency modulation.

A plurality of microphone modules according to this present disclosure are expected to be substantially congruent in their characteristics of frequency response, sensitivity, and directionality. This congruency enables several non-linear aspects to be established as a standard by testing and thereafter, for the plurality of microphones modules, these non-linear aspects can be corrected via signal processing into linear characteristics. In this context the plurality of microphones modules can be considered as a plurality of ideal or near-ideal 3D bidirectional microphone modules.

The present disclosure provides a 3D sound analysis system comprising a cluster of 3D responsive microphone modules and a signal processor. The cluster of 3D responsive microphone modules and the signal processor allows the analysis of a detectable 3D sound environment. The system enables capabilities such as:
a) identifying a plurality of 3D locations of a plurality of sound sources;
b) isolating an individually received sound from each sound source with good to high fidelity;
c) signal correlation from each microphone module to improve received signal to noise ratio;
d) compensating a plurality of received signals for high frequency roll-off per the distance to each sound source;
e) reconstructing a plurality of emanating sound waves at each sound source origin with good to high fidelity generally including some or all of its lobal patterns; and
f) selecting various sound sources or 3D regions or directions as output.

In an embodiment, a 3D responsive microphone module is preferably configured in a 3D arrangement around either a central sensing position or a central sensing element to obtain bidirectional vector information relating to all impinging sound waves from detectable sound sources.

In an embodiment, the cluster of microphone modules is configured in a 3D arrangement, typically as four microphone modules arranged as a tetrahedral. Due to their different 3D positions, each microphone module will obtain a slightly different 3D bidirectional vector information set relating to each sound source.

In an embodiment, a distribution of microphone clusters is used to collect sound source signal information from a large volume.

In an embodiment, the signal processor is programmed to:
retrieve, from each of the microphone modules, their 3D bidirectional vector information sets;
convert the 3D vector information sets into digital information sets;
calculate from the digital information sets, all of the 3D bidirectional vectors for every microphone module;
calculate the 3D intersection points of the bidirectional vectors that are common to all microphone modules, noting that only such common intersection points represent the true 3D positions of the sound sources;
calculate the different distances from each microphone module to each sound source to thereby further calculate the arrival time difference to each microphone module from each sound source, to thereby further calculate time arrival synchronisation of the collective received signals from each sound source, to thereby via such signal correlation maximise the signal to noise ratio of received sounds;
calculate and correct for high frequency sound roll off from each sound source; and
provide as output the digital representation of the sound waves emanating in the direction of the microphone cluster from each sound source.

In an embodiment, each of the bidirectional microphones of the cluster of microphone modules is substantially congruent in their characteristics such as frequency response, sensitivity, and directionality wherein such are established in manufacture by testing as a standard and for quality control, thereby enabling from any bidirectional microphone:
a) non-linear aspects of the characteristics (such as frequency response and sensitivity) to be corrected via the signal processor into linear characteristics, thereby approaching in effective signal output the qualities of ideal or near-ideal bidirectional microphones; and
b) consistent and interpretable output.

Any given microphone module can provide sufficient 3D sound information that the signal processor can determine the bidirectional vectors in space pointing to a plurality of detectable sound source in conjunction with determining the received sound from each detectable sound source. The resulting cluster of microphone modules in combination with further signal processing can identify via the intersection points of the bidirectional vectors from each microphone module the 3D location of each detectable sound source.

In an embodiment, the bidirectional microphones of any given microphone module are placed in a 3D arrangement, wherein at least three bidirectional microphones are aligned on x-y-z axes. The 3D arrangement may comprise four bidirectional microphones placed tetrahedrally, or any other number of bidirectional microphones placed in a suitable polygonal arrangement.

In an embodiment, the cluster of microphone modules are placed in a 3D arrangement. Preferably four microphone modules are placed tetrahedrally, whilst noting that five or more microphone modules will tend to provide improved 3D signal information.

In a first aspect, there is provided a plurality of high frequency sound waves in the form of substantially narrow beams, comprised of either continuous waves or pulses, between a plurality of transmitter and receiver pairs that act in the capacity of the bidirectional microphones.

Incoming sound waves lateral to the axis of the narrow beams modulate the path length of the beams such that continuous beams are received as FM (frequency modulation), and pulses are received as PPM (pulse position modulation) preferably via zero crossing detection at the receivers.

The plurality of transmitter and receiver pairs are generally in close proximity, and are preferably arranged with the narrow beams intersecting at their mid points in an x-y-z axes arrangement.

The plurality of narrow beams are preferably at a substantially high frequency to provide both substantially narrow beams and substantially high resolution of the impinging sound waves.

In a preferred form, CMUTs (Capacitive Micromachined Ultrasonic Transducers) are used as the plurality of transmitter and receiver pairs, operating with pulsed sonic waves at a preferred frequency range of 10 MHz to 40 MHz.

Other forms of transmitter and receiver pairs can be used, generally with continuous beams. Examples include ceramic, crystal and electret transducers, and fibre optic microphone receivers.

In a second aspect, a levitated bubble being actively centred is employed as the element reacting to incoming sound waves wherein:
a) the levitated bubble can move with equal ease in any direction thus acting as an omnidirectional element; and
b) the levitated bubble may have various combinations of bubble composition or structure;
c) a plurality of centring devices for actively centring the levitated bubble may be used; and
d) a plurality of sensing devices for sensing the position of the levitated bubble may be used.

The levitated bubble:
a) is substantially thin to minimize mass and maximise sensitivity; and
b) is small in diameter in comparison to the wavelength of the highest frequency of interest of the incoming sound waves; and
c) has porosity to maintain its diameter with changing atmospheric conditions, wherein porosity can be incorporated by means such as inherent porosity in a polymer or epoxy film, evaporative particles incorporated in a polymer or epoxy film, bombardment by heavy ions and so forth; and
d) has quality control in manufacturing to ensure that any levitated bubbles for utilisation meet substantially strict standards thus ensuring congruency in manufacture.

In an embodiment, active centring of the levitated bubble is achieved using the plurality of centring devices that generate magnetic fields. The levitated bubble, preferably made of polymer or epoxy material, may contain iron nanoparticles or other magnetic responsive material. The active centring may be enabled using the plurality of centring devices being preferably four electromagnets in a tetrahedral arrangement.

In another embodiment, the levitated bubble may be actively centred using the plurality of centring devices that generate electrostatic charge. The levitated bubble, preferably made of polymer or epoxy material, may have a static charge. The active centring may be enabled using the plurality of centring devices preferably being four electrostatic plates in a tetrahedral arrangement.

In a further embodiment, the levitated bubble is actively centred via high frequency sound waves such that the levitated bubble is either within a permanent null, within a web of glancing beams, or is nudged into position via glancing beams.

The position of the levitated bubble is preferably sensed using the plurality of sensing devices based on laser interferometry or by forming a capacitor with three sets of plates in x-y-z axes as three RF (radio frequency) oscillators in the like manner of an RF condenser microphone. Additionally, the plurality of sensing devices may use any other suitable sensing methods such as RF reflection or sonic beam reflection.

In a third aspect, a plurality of tethered bubbles, their tethers or a combination of the tethered bubbles and tethers are employed as an element reacting to incoming sound waves wherein:
a) preferably three elements are used with each element reacting to incoming sound waves;
b) preferably the three elements are tethered bubbles;
c) the tether of each of the tethered bubbles is preferably axial either through the bubble or by bonding the tether ends to the bubble;
d) the tether of each of the tethered bubbles is substantially thin and elongated;
e) the tether of each of the tethered bubbles is comprised of an elastic polymer or fibre;
f) each tethered bubble is located in the centre of its tether;
g) the tethered bubble can move in the lateral direction to the tether; and
h) the plurality of tethered bubbles may be formed from various combinations of bubble composition or structure.

In an embodiment, the tethered bubble:
a) is substantially thin to minimize mass and therefore maximise sensitivity;
b) is preferably small in diameter in comparison to the wavelength of the highest frequency of interest of the incoming sound waves;
c) has porosity to thereby maintain its diameter with changing atmospheric conditions, wherein porosity can be incorporated by means such as inherent porosity in a polymer or epoxy film, evaporative particles incorporated in a polymer or epoxy film, bombardment by heavy ions and so forth; and
d) has quality control in manufacturing to ensure that accepted bubbles for utilisation meet substantially strict standards thus ensuring congruency in manufacture.

In an embodiment, the plurality of sensing devices is based on laser interferometry or by forming a capacitor with three plates in x-y-z axes as three RF oscillators in the like manner of an RF condenser microphone. Additionally, the plurality of sensing devices may use any other suitable sensing methods such as RF reflection or sonic beam reflection.

It will be appreciated that there are many common existing techniques that can be applied to the forms discussed herein such as using polyhedral cages to support microphone modules, dust protective shields, cabled or wireless operation, laser scanning of the environment to aid or accompany sound source positioning data, using coils instead of straight tethers, and replacing tethers with aerogel or webbing.

It will be appreciated that there are many potential applications for the microphone system such as isolating individual voices in a crowd or choir, isolating instruments in an orchestra, isolating a speakers' voice in a noisy environment, wildlife monitoring, security, aircraft flight recorders, industrial monitoring, noise & vibration identification for manufacture or fault finding, and media productions.

### BRIEF DESCRIPTION OF THE DRAWINGS

For the purposes of clarity, all drawings are shown with no or minimal mounting structures and coverings, and furthermore are shown without electronics, cables and so forth as these are generic to the art, wherein any suitable types can be used and it is to be assumed that such would be utilised in all complete designs.

Preferred generic embodiments will be described, by way of example, with reference to the accompanying drawings in which:

FIG. 1 is diagrammatic view of a 3D sound analysis system that comprises a cluster of microphone modules in a 3D arrangement, wherein each microphone module is 3D responsive, wherein each microphone module comprises a 3D arrangement of bidirectional microphones, whereupon signal outputs from this system are processed by a signal processor programmed to provide a processed signal output.

FIG. 2 is a perspective view with a cubical reference frame of a microphone module illustrating the general principle of operation wherein at least three bidirectional microphones of any suitable type such as high frequency sound transducers, are preferably orientated in X-Y-Z coordinates, and furthermore preferably sense impinging passing sound waves at a central point, wherein this system forms the first major aspect of a microphone module.

FIG. 3 shows a variant of the microphone module of FIG. 2 illustrating four bidirectional microphones in a different spatial arrangement, demonstrating that three or more bidirectional microphones can be used and in any suitable spatial arrangement according to this disclosure.

FIG. 4, FIG. 5, FIG. 6 and FIG. 7 are perspective views with a cubical reference frame of a second major aspect of the microphone module that comprises a levitated bubble acting as a 3D displacement sensitive device to impinging sounds from any 3D direction.

Levitated bubble means may comprise any suitable means such as magnetic, electrostatic, ultrasound, ion beam and so forth.

Bubble displacement sensor means may comprise any suitable means such as laser interferometry, ultrasound, RF capacitance resonant circuit and so forth.

FIG. 4 shows a bubble levitation means comprising four tetrahedrally arranged centring devices such as electromagnets acting upon a magnetically sensitive bubble.

FIG. 5 shows the system of FIG. 4 with the addition of four tetrahedrally arranged displacement sensitive devices such as laser interferometers reflecting off the levitated bubble.

FIG. 6 shows the system of FIG. 4 with the addition of three x-y-z axes arranged displacement sensitive devices such as laser interferometers reflecting off the levitated bubble.

FIG. 7 shows the system of FIG. 4 with the addition of three x-y-z axes arranged displacement sensitive devices such as RF capacitance resonant circuits in conjunction with an electrically conductive levitated bubble.

FIG. 8 is a perspective view with a cubical reference frame of a third aspect of the microphone module according to the present disclosure, in which three fibres or bubbles centrally tethered by fibres with the fibres preferably elastic, are orientated in X-Y-Z coordinates and particularly act as lateral displacement sensitive devices to impinging sounds as an active component of bidirectional microphones, using any suitable displacement sensor method of bubbles or fibres such as laser interferometry, RF tuned circuit, ultrasound, stretching of the fibres by laser or tension, or if the fibre is conductive by RF tuned circuit, or by any other suitable sensing means, wherein furthermore fibres used by themselves may include alternate attached objects to improve sensitivity, wherein other suitable numbers or orientation of means comprising bubbles or fibres or bidirectional microphone can be used.

FIG. 9 illustrates a variant of FIG. 8 wherein only two tethered bubbles are used as components of the at least three bidirectional microphones orientated in X-Y-Z coordinates, according to a further form of the present invention.

FIG. 10 is a perspective view of examples of Platonic Solids that would suit as, but be not limited to, framework forms or spatial arrangements for microphone modules or cluster arrangements of microphone modules, according to all forms of the present invention.

FIG. 11 illustrates a basic means of forming a bubble that is suitable for any bubble application of the present invention, comprising epoxy compound to form the bubble, a bubble forming means, and a UV curing system for the bubble.

FIG. 12 illustrates a perspective view of a manufacturable microphone module utilizing a magnetically levitated bubble, comprising a structural cage, bubble protection cage, bubble incorporating magnetic responsive material, electromagnets for bubble positioning, infra-red LEDs reflectometers for initial bubble centring measurement, and laser interferometers to sense bubble deflection from impinging sound waves.

### DETAILED DESCRIPTION

In the interests of clarity, sound sources are not illustrated in any drawings, but are assumed to be present.

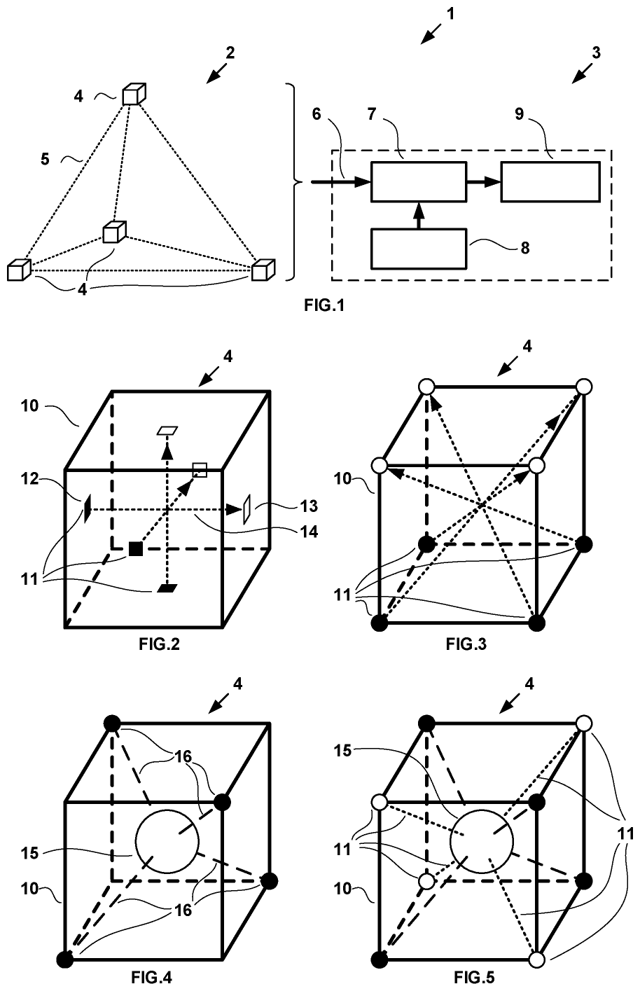

With reference to diagrammatic view FIG. 1 and perspective view FIG. 2, a 3D sound analysis system 1 according to the generic embodiment of the disclosure is illustrated that comprises a cluster of microphone modules 2 and a signal processor 3 that together provide good 3D analysis and modelling of sound sources and selected signal output forms thereof.

In this embodiment, the cluster of microphone modules 2 is comprised of four or more microphone modules 4 that are arranged in any suitable 3D arrangement whereupon their signal outputs 6 are received by the signal processor 3 to create a processed signal output 9.

The 3D positions and orientations of all the microphone modules 4 in relation to a 3D reference point must be inputted to signal processor 3 to enable meaningful data processing and output.

A microphone module 4 as illustrated in FIG. 2, with generic supporting framework 10, comprises at least three bidirectional microphones 11 orientated in X-Y-Z coordinates to thereby obtain a set of bidirectional information about sound arriving from all detectable sound sources in three dimensions, preferably from a common central position, whereupon the set of bidirectional information is then processed as a first signal processing step by signal processor 3 to initially convert the received information into digital information, and then to solve this information into a 3D computer simulation of bidirectional vectors pointing to detectable sound sources and to isolate sounds received from these directions.

The bidirectional information from the cluster of microphone modules 2 in FIG. 1 can be generically signal processed as a second signal processing step by signal processor 3 to determine the intersection points of the bidirectional vectors pointing to detectable sound sources, to thereby determine the real 3D locations of all detectable sound sources and the refined received sound signals thereof.

The refining of received sound signals is possible because the distance to all real 3D sound sources is now known, and hence the arrival times and relative magnitudes of the sound signals can be calculated, whereupon compensation can be made for high frequency roll off, whereupon via signal correlation, errors and noise can be minimized.

Further signal processing can then yield other desirable information such as the signals and approximate lobal patterns emanating from sound sources, selected output and signal manipulation thereof, apparent sound sources that are actually reflections off hard surfaces, and so forth.

A sample processor program 8 outline for signal processor 3 might be:
a) Determine bidirectional orientations to all sound sources from each microphone module 4;
b) Determine 3D locations of all sound sources via the corresponding intersection points of all bidirectional orientations in the cluster of microphone modules 2;
c) Determine the distance from each sound source to each microphone module 4 to thereby compensate for high frequency roll-off;
d) Determine the actual magnitude and a maximal of lobal patterns for each sound source;
e) Select as output the signals from the desired number of sound sources;
f) Apply signal conditioning as desired such as selected bandwidth, tone control, and position of any virtual microphones;
g) Apply signal mixing as desired;
h) Output the desired signal information as processed signal output 9.

In further reference to FIG. 2 in conjunction with a further form of FIG. 2 as perspective view FIG. 3, it can be seen that one example of four bidirectional microphones 11 intersects their sensing at a central point using a different 3D positioning arrangement. Obviously, many other arrangements such as tetrahedral or using a larger number of bidirectional microphones 11 are possible, but increasing the number of bidirectional microphones 11 within a single microphone module 4 generally adds little extra signal information compared to increasing the number of microphone modules 4 comprising the cluster of microphone modules 2.

In yet further reference to FIG. 2, illustrated is the first of three major aspects of 3D bidirectional microphone systems wherein three bidirectional microphones 11 are in the form of ultrasonic beam transducers each comprising a transmitter 12, receiver 13 and ultrasonic beam 14. As both a small sampling volume and a sampling frequency much higher than the highest sound frequency of interest are desirable for quality sound recording, one preferable form of ultrasonic beam transducers is a CMUT (Capacitive Micromachined Ultrasonic Transducer) preferably operating at 10 MHz to 40 MHz. These devices operate via sending and receiving sonic pulses, wherein the substantially high frequency pulse rate creates a substantially narrow beam of acoustic pulses, whereupon infringing lateral sound waves cause deviation of the narrow beam thus modulating the path length and hence the arrival time of the pulses, thereby causing pulse position modulation as output signals.

An alternate form of transducer is a continuous wave transducer such as a ceramic ultrasonic transducer wherein impinging sound waves cause FM modulation as output signals.

An advantage of these systems is simplicity combined with substantially wide frequency and dynamic ranges.

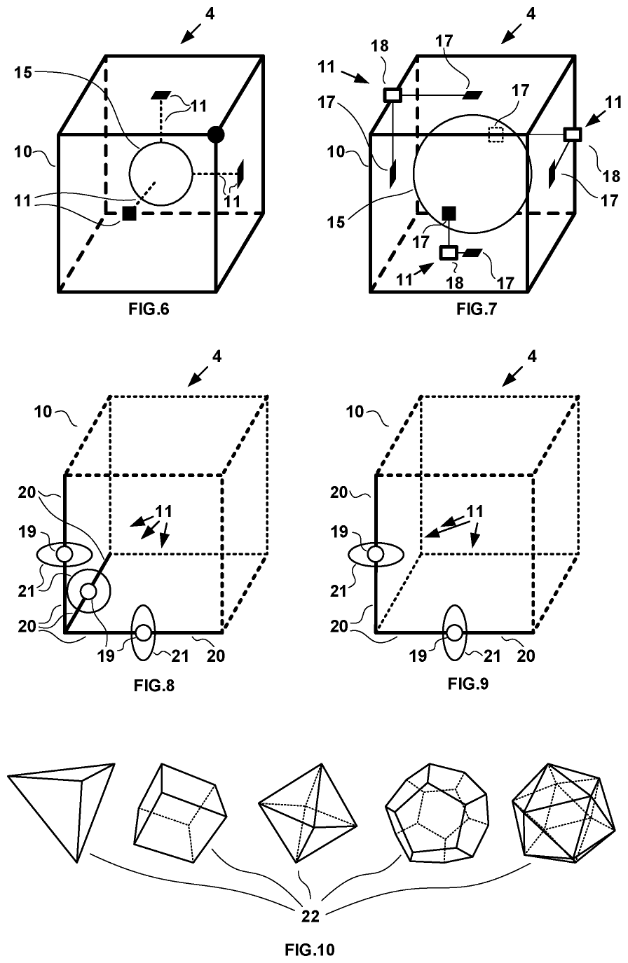

With reference to perspective view FIGS. 4 to 7, illustrated is the second of three major aspects of 3D bidirectional microphone systems according to the present invention wherein a levitated bubble 15 is actively centred by a centring device 16, wherein levitated bubble 15 acts as a displacement sensitive device to impinging sounds from any 3D direction, wherein displacement of levitated bubble 15 is detected by a sensing device based upon any suitable type of sensor such as a laser interferometer or ultrasound in the manner of FIG. 6, a RF capacitance resonant circuit in the manner of FIG. 7, and so forth, whereby levitated bubble 15 and its sensing device form a bidirectional microphones 11.

The preferred number and orientation of bidirectional microphones 11 is in like manner to FIG. 2, but may be greater in number and with different orientations.

The preferred number and orientation of the centring device 16 is four in number and arranged tetrahedrally, but may be greater in number and with different orientations.

Levitated bubble 15 is preferably substantially thin and lightweight to maximise sensitivity to sound waves.

Levitated bubble 15 is preferably composed of a material such as polymer or epoxy and any additives thereunto such as nanoparticle iron, reflective additives, conductive additives, evaporative particles and so forth.

Levitated bubble 15 is preferably porous to air so as to not be affected by changing air pressure, wherein such porosity may be inherent to its material of construction, be formed via doping the formative material with evaporative particles, or bombarding the bubble with fine particles.

Levitated bubbles 15 in production are to be selected for substantially high congruency according to a standard to ensure congruent responses operationally.

The centring device 16 may be based upon any suitable method such as magnetic, electrostatic, ultrasound, ion beam, etc, wherein for magnetic systems the bubble is doped with magnetic sensitive material such as iron nanoparticles, wherein for electrostatic systems the bubble may either inherently respond electrostatically or be imbued with a charge.

Preferably the centring device 16 is based upon a method in sequence firstly magnetic, secondly electrostatic, thirdly via ultrasound, and fourthly by any other suitable methods such as micromechanically, wherein common devices per the art locally generate either magnetic fields, electric fields, or ultrasonic beams, or perform mechanical actions, and so forth.

FIG. 4 illustrates the centring device 16.

FIG. 5 illustrates FIG. 4 with a tetrahedral bidirectional microphone 11 means.

FIG. 6 illustrates a laser, ultrasound or other suitable bidirectional microphone 11 means per the art.

FIG. 7 illustrates a RF capacitance resonant circuit bidirectional microphone 11 means per the art, wherein levitated bubble 15 is electrically conductive, and preferably each bidirectional microphone 11 utilises two conductive plates 17 in conjunction with any capacitive sensitive means 18 such as part of a RF tuned circuit.

With reference to perspective view FIG. 8 and FIG. 9, illustrated is the third of three major aspects of 3D bidirectional microphone systems, wherein each bidirectional microphone 11 means comprises either a tethered bubble 19 that is tethered in place by an elastic fibre 20 or by the elastic fibre 20 alone thereby allowing lateral movement 21 of the tethered bubble 19 or the elastic fibre 20 in response to impinging sound waves, combined with any suitable accompanying sensing means to provide signal output means of lateral displacement of bubbles or fibres or elastic fibre stretching is used such as a laser interferometer, RF circuit, ultrasound, electrical resistance, or tension or other suitable means is used.

The elastic fibres 20 that are used by themselves may include alternate attached objects to improve sensitivity.

Other numbers of the tethered bubbles 19, the elastic fibres 20 and the bidirectional microphones 11 means can be used in any suitable combination and orientation.

Lateral bubble or fibre deflection sensing means have not been illustrated, but would lie in the plane of the indicative circles at right angles to the elastic fibre 20 orientation depicting lateral movement 21.

FIG. 8 illustrates three tethered bubbles 19 on three elastic fibres 20 wherein each set can be used to form a bidirectional microphone 11, whilst FIG. 9 shows a variation wherein two tethered bubbles 19 mounted onto two elastic fibres 20 wherein one set can be used to form two bidirectional microphones 11 whilst the other set forms one bidirectional microphone 11.

The tethered bubbles 19 can be mounted on the elastic fibres 20 either by being pierced by the elastic fibre 20, or by having two shorter elastic fibres 20 being bonded to opposite ends.

It is understood that other numbers of the tethered bubbles 19, the elastic fibres 20, and the bidirectional microphone 11 means can be used in any suitable orientation.

With reference to perspective view FIG. 10, illustrated are perspective views of examples of a Platonic Solids 22 that would suit as, but be not limited to, framework forms or spatial arrangements for microphone modules 4 or for cluster arrangements of microphone modules 4, wherein such shapes can have manufacturing or positioning advantages such as strength, orientation and positional congruency, according to all aspects of the present disclosure.

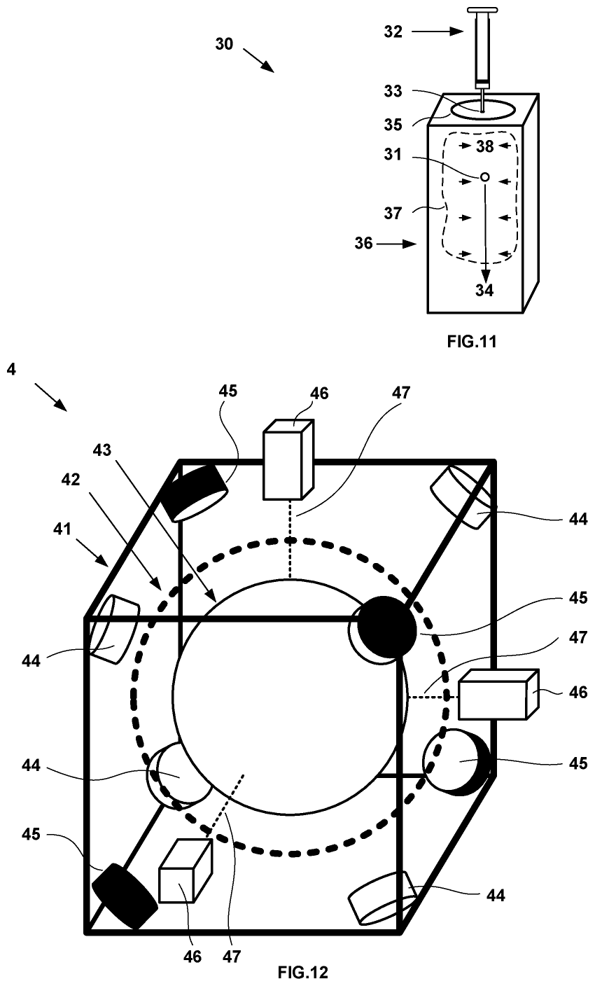

With reference to perspective view FIG. 11, illustrated is a basic means 30 of forming a bubble 31 that is suitable for any bubble application of the present disclosure, wherein basic means 30 comprises vertically downwards orientated air-filled syringe 32 incorporating a square ended needle tip, whereupon on the needle tip is placed a small blob 33 of UV setting epoxy compound incorporating magnetic responsive material that would set in a few seconds upon exposure to UV light, whereupon the plunger of syringe 32 can be speedily depressed to form epoxy bubble 31 that would detach from the syringe and move vertically downwards in the direction of arrow 34, whereupon bubble 31 would enter a small opening 35 in UV LED lined box 36 illustrated with cut away view 37, whereupon the UV LEDs that are not illustrated for clarity would then activate for a few seconds to emit UV light per arrows 38 to fully cure epoxy bubble 31 before it reaches the bottom of box 36, whereupon bubble 31 would then be ready for use in a microphone module.

The incorporation of magnetic responsive material particularly suits a magnetically levitated bubble system, and is not required in an electrostatically levitated bubble system.

A suitable magnetic responsive material is magnetite in the form of either nanoparticles, particles or compounds.

Iodine in the form of either nanoparticles, particles or compounds that is incorporated into the epoxy before curing will provide microscopic porosity in bubble 43 walls after the iodine sublimes, providing air pressure equalisation without damage to bubble 43.

With reference to perspective view FIG. 12, illustrated is manufacturable microphone module 4, comprising structural cage 41, bubble protection cage 42, bubble 43 incorporating magnetic responsive material, infra-red LED reflectometer modules 44 for initial bubble centring measurement, electromagnets 45 for bubble positioning, and laser interferometers 46 with laser beams 47 to sense bubble 43 deflection from impinging sound waves.

Structural cage 41 needs to be stiff, and a desirable material is fibreglass circuit board, as such a design will also allow integrated wiring to various components.

Bubble protection cage 42 as a spherical plastic mesh form is easily mouldable and protects the bubble from both external impact and internal impact.

Bubble 43 incorporating magnetic responsive material can be constructed as described per bubble 31 of FIG. 11.

Four infra-red LED reflectometer modules 44 for initial bubble 43 centring measurement are arranged tetrahedrally, whereupon when bubble 43 is centred the signal readings are identical, and when bubble 43 is off centre, the proportionally different signal readings can be used in conjunction with a signal processor such as signal processor 3 to determine the direction that bubble 43 needs to be moved in by electromagnets 45. The action of this system is primarily for initial power up when bubble 43 will be resting against bubble protection cage 42. The system will also come into play if bubble 43 is forcibly moved out of position such as by a mechanical shock or wind gust.

It will be seen that the functionality of infra-red LED reflectometer modules 44 could be replaced by radio frequency or sonic reflection systems.

Bubble 43 positioning is accomplished by four electromagnets 45 arranged tetrahedrally, wherein bubble 43 can be moved in any 3D direction by varying the magnetic field strength for each electromagnet 45, whereby such corrections would be provided by a signal processor such as signal processor 3 using data from either of infra-red LED reflectometer modules 44 or laser interferometers 46.

Three laser interferometers 46 with laser beams 47 to sense bubble 43 deflection from impinging sound waves are mounted along x-y-z axes intersecting at the central position for bubble 43, wherein these bubble 43 deflection measurements are extremely precise.

When bubble 43 is centred, laser interferometers 46 serve two functions via a signal processor such as signal processor 3, firstly to provide incremental positioning corrections for bubble 43 to counteract the displacement motion caused by gravity, and secondly to detect all displacements in 3D caused by impinging sound waves, wherein digital representations of bidirectional vectors to each sound source will be generated.

If only an omnidirectional microphone response to impinging sound waves on bubble 43 is needed, then the signal output can be used as is. If isolation of each sound source in a selected 3D space is required, then a cluster of microphone modules 4 is required as discussed in FIG. 1. For large volumes of space, such as an orchestra or a stadium, multiple distributed sets of clusters of microphone modules 4 are required.

Although not described for clarity, it is understood per the art that microphone module 4 would also have some form of dust cover, and usually be mounted in a housing such as that used for a hand-held microphone.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

In addition, the foregoing describes only some embodiments, and alterations, modifications, additions and/or changes can be made thereto without departing from the scope and spirit of the disclosed embodiments, the embodiments being illustrative and not restrictive.

Furthermore, the disclosure has been described in connection with what are presently considered to be the most practical and preferred embodiments, it is to be understood that the disclosure is not to be limited to the disclosed embodiments, but on the contrary, is intended to cover various modifications and equivalent arrangements included within the spirit and scope of the disclosure.

Also, the various embodiments described above may be implemented in conjunction with other embodiments, for example, aspects of one embodiment may be combined with aspects of another embodiment to realize yet other embodiments.

In the claims which follow, and in the preceding description, except where the context requires otherwise due to express language or necessary implication, the word “comprise” and variations such as “comprises” or “comprising” are used in an inclusive sense, i.e., to specify the presence of the stated features but not to preclude the presence or addition of further features in various embodiments of the apparatus and method as disclosed herein.

In the foregoing description of preferred embodiments, specific terminology has been resorted to for the sake of clarity. However, the disclosure is not intended to be limited to the specific terms so selected, and it is to be understood that each specific term includes all technical equivalents which operate in a similar manner to accomplish a similar technical purpose. Terms such as “locations” and “positioning”, “framework” and “acoustic”, “sound”, and “high fidelity” and the like are used as words of convenience to provide reference points and are not to be construed as limiting terms.

1. A sound analysis system comprising: a cluster of microphone modules configured in a 3D arrangement, wherein each microphone module is configured to obtain a set of bidirectional information; and a signal processor:
wherein the signal processor is programmed to retrieve, from each of the microphone modules, their 3D bidirectional vector information sets;
convert the 3D vector information sets into digital information sets;
calculate from the digital information sets, all of the 3D bidirectional vectors for every microphone module;
calculate the 3D intersection points of the bidirectional vectors that are common to all microphone modules, noting that only such common intersection points represent the true 3D positions of the sound sources;
calculate the different distances from each microphone module to each sound source to thereby further calculate the arrival time difference to each microphone module from each sound source, to thereby further calculate time arrival synchronisation of the collective received signals from each sound source, to thereby via such signal correlation maximise the signal to noise ratio of received sounds;
calculate and correct for high frequency sound roll off from each sound source; and
provide as output the digital representation of the sound waves emanating in the direction of the microphone cluster from each sound source.

2. The system according to claim 1, wherein each microphone module comprises at least three bidirectional microphones.

3. The system according to claim 2, wherein the at least three bidirectional microphones are orientated at equal angles to each other along each x-y-z axis or tetrahedrally.

4. The system according to claim 2, wherein the at least three bidirectional microphones are configured to obtain the set of bidirectional information from a common 3D location or a common sound sensitive element or a plurality of sound sensitive elements near each other.

5. The system according to claim 2, wherein each of the bidirectional microphones are substantially congruent in frequency response, sensitivity, and directionality.

6. The system according to claim 2, wherein the signal processor is further programmed to convert the set of bidirectional information, retrieved from each microphone module, into a set of digital information by comparing a signal strength and an orientation of each microphone to derive a solution set of a plurality of bidirectional vectors in space pointing to a plurality of detectable sound sources in conjunction with determining the received sound from each detectable sound source.

7. The system according to claim 6, wherein the signal processor is further programmed to:
determine a plurality of intersection points of the plurality of bidirectional vectors; and
determine a 3D location of each detectable sound source from the plurality of detectable sound sources.

8. The system according to claim 4, wherein the at least three bidirectional microphones are arranged around a target space.

9. The system according to claim 4, wherein the at least three bidirectional microphones are arranged around a levitated bubble or a tethered bubble.

10. The system according to claim 8, wherein the at least three bidirectional microphones are each configured as an x-y-z orientated pair of a transmitter and a receiver.

11. The system according to claim 10, wherein the x-y-z orientated transmitter and receiver pair are a pair of capacitive micromachined ultrasonic transducers or a pair of ceramic resonators

12. The system according to claim 10, wherein the x-y-z orientated transmitter and receiver pair is generally configured with transmission frequencies in the range of 100 kHz to 40 MHz.

13. The system according to claim 9, wherein the levitated bubble is configured to be actively centred using a magnetic field or an electric field.

14. The system according to claim 13, wherein the levitated bubble is deflected by impinging sound waves from a plurality of external sound sources.

15. The system according to claim 13, wherein the levitated bubble incorporates magnetically influenced particles, nanoparticles or compounds.

16. The system according to claim 14, wherein the position of the levitated bubble is measured by a plurality of x-y-z orientated sensors.

17. They system according to claim 16, wherein the plurality of x-y-z-orientated sensors are either a plurality of laser interferometry systems, a plurality of radio frequency oscillator systems, a plurality of radio frequency reflection systems, a plurality of optical reflection systems, or a plurality of sonic beam reflection systems.

18. The system according to claim 9, wherein the tethered bubble comprises at least three sets of bubbles each held by at least one elastic fibre orientated respectively in x-y-z directions, each set of bubbles is supported at the midpoint of the at least one fibre and is adapted to move laterally in relation to its suspension axis in response to impinging sound waves.

19. The system according to claim 18, wherein the at least three sets of bubbles comprise a first bubble that is axially penetrated by a fibre, a second bubble that is bonded axially to the endpoints of a pair of fibres and a third bubble having at least three axial fibres enclosing it in a tetrahedral cage.

20. The system according to claim 19, wherein the fibres are used to detect sound.

21. The system according to claim 18, wherein the fibres as made from fibre coils, fibre springs, webbing, foam, aerogel.
